(19) United States
(12) Patent Application Publication
(10) Pub. No.: US 2017/0273051 A1
(43) Pub. Date: Sep. 21, 2017

(54) SYSTEMS AND METHODS TO PROVIDE NOTIFICATIONS BASED ON FAILURE OF FIRST DEVICE TO COMMUNICATE WITH SECOND DEVICE

(71) Applicant: Lenovo (Singapore) Pte. Ltd., New Tech Park (SG)

(72) Inventor: Douglas Warren Robinson, Raleigh, NC (US)

(21) Appl. No.: 15/076,027

(22) Filed: Mar. 21, 2016

(51) Int. Cl. H04W 68/00; H04W 4/00

(52) U.S. Cl. CPC H04W 68/005; H04W 4/008

(57) ABSTRACT

In one aspect, a first device includes a processor, a communication interface accessible to the processor, and storage accessible, to the processor. The storage bears instructions executable by the processor to attempt to communicate, using the communication interfaces with a second device with which the first device has previously communicated The instructions are also executable by the processor to provide a notification indicating that the second device is not present responsive to a determination that communication cannot be established with the second device.

### FIELD

The present application relates generally to systems and methods to provide notifications based on a failure of a first device to communicate with a second device.

### BACKGROUND

As recognized herein, people sometimes forget to bring one or more smart devices with them when they leave a location such as their home or car and intend to bring those smart device(s). As also recognized herein, there are currently no adequate ways to address the foregoing problem.

### SUMMARY

Accordingly, in one aspect a first device includes a processor, a communication interface accessible to the processor, and storage accessible to the processor. The storage bears instructions executable by the processor to attempt to communicate, using the communication interface, with a second device with which the first device has previously communicated. The instructions are also executable by the processor to provide a notification indicating that the second device is not present responsive to a determination that communication cannot be established with the second device.

In another aspect, a method includes, at a first device, attempting to communicate with a second device with which the first device has previously been paired for communication. The method also includes providing a notification responsive to a failure to communicate with the second device based on the attempting.

In still another aspect, a first device includes a processor, a communication interface accessible to the processor, and storage accessible to the processor. The storage bears instructions executable by the processor to attempt to communicate, using the communication interface and based on one or more identified user patterns, with a second device with which the first device has previously communicated. The instructions are also executable to take a first action responsive to an inability to communicate with the second device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3A, 3B, and 4 are How charts of example algorithms in accordance with present principles;

FIG. 5 is an example data table in accordance with present principles; and

FIGS. 6-8 are example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local, intranet, or a virtual private network.

As used herein, instructions refer to computer-implemented steps for processing information in the system, instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical, blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

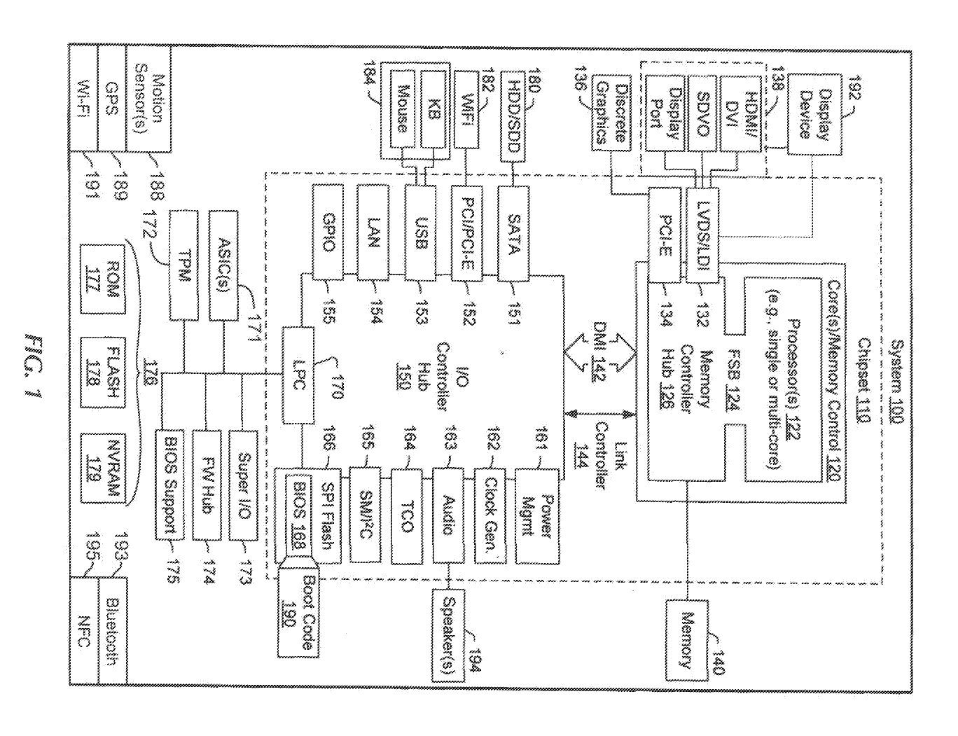

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front, side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc. ). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach, to an accelerated graphics port (AGP). For example, the memory controller hub 126 may include a 16-lane (x16) PCI-E port for an external PCI-E-based graphics card (including, e.g., one of more CPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI Interfaces), one or more USB interfaces 153, a LAN interface 154 (more generally a communication interface and/or network interface for communication over at least one network such as the Internet, a WAN, a LAN, etc. under direction of the processor(s) 122), a general purpose I/O interlace (GPIO) 155, a low-pin count (LPC) interface 170, a power management interface 161, a clock generator interface 165, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be is the form of a chip that can be used to authenticate software and hardware devices. For example, a TPM maybe capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, in some embodiments the system 100 may include one or more motion sensors 188, such as a gyroscope that senses and/or measures the orientation of the system 100 and provides input related thereto to the processor 122 and an accelerometer that senses acceleration and/or movement of the system 100 and provides input related thereto to the processor 122. The system 100 may also include a GPS transceiver 189 that is configured to receive geographic position information from at least one satellite and provide the information to the processor 122. However, it is to be understood that another suitable position receiver other than a GPS receiver may be used in accordance with present principles to determine the location of the system 100.

FIG. 1 also shows that the system 100 may include a wireless local area network (WLAN) and/or Wi-Fi transceiver 191 for communicating with other devices in accordance with present principles using WLAN and/or Wi-Fi communication protocols. Still further, the system 100 may include a Bluetooth and/or Bluetooth low energy (BLE) communication element 193 (e.g., a Bluetooth 4.0 communication element) for communicating with other devices in accordance with present principles using Bluetooth communication protocols, as well as a near field communication (NFC) element 195 for communicating using with other devices in accordance with present principles using NFC protocols. However, note that still other communication, interfaces other than Bluetooth and NFC communication elements may be used for communication with other devices in accordance with present principles, including interfaces for wired communication, such as micro-USB 3.0 communication interfaces.

Additionally, though now shown for clarity, in some embodiments the system 100 may include an audio receiver/microphone that provides input to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video.

It is to be understood that an example client device or other machine/computer may include fewer or more features than shown on the system 100 of FIG. 1. In any case, it is to be understood at least based on the foregoing that the system 100 is configured to undertake present principles.

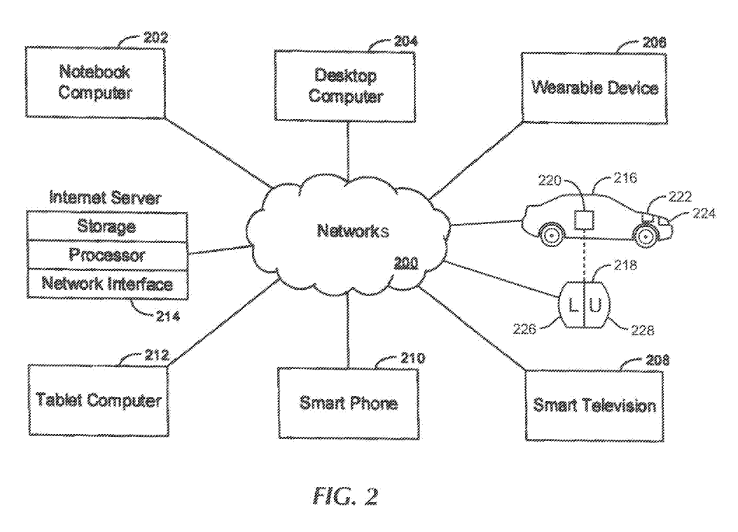

Turning now to FIG. 2, example devices are shown communicating over one or more networks 200 such as the Internet, a local area network (LAN), a Bluetooth communication network, an NFC network, etc. in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a vehicle 216, a key fob 218, and a server 214 such as an Internet server that may provide cloud storage accessible to the devices 202-212, 216, and 218. It is to be understood that the devices 202-218 are configured to communicate with each other over the network(s) 200 to undertake present principles.

Describing the vehicle 216 in more detail, it may include at least one system 220 that may include some or all of the components described above in reference to the system 100, as well as a horn 222 (or other noise-generating mechanism) and headlights 224. The key fob 218 may wirelessly communicate (e.g., using radio frequency (RF) communication) with the vehicle 216 to lock and unlock doors and other portions of the vehicle 216 based on selection of a lock button 226 and an unlock button 228, respectively.

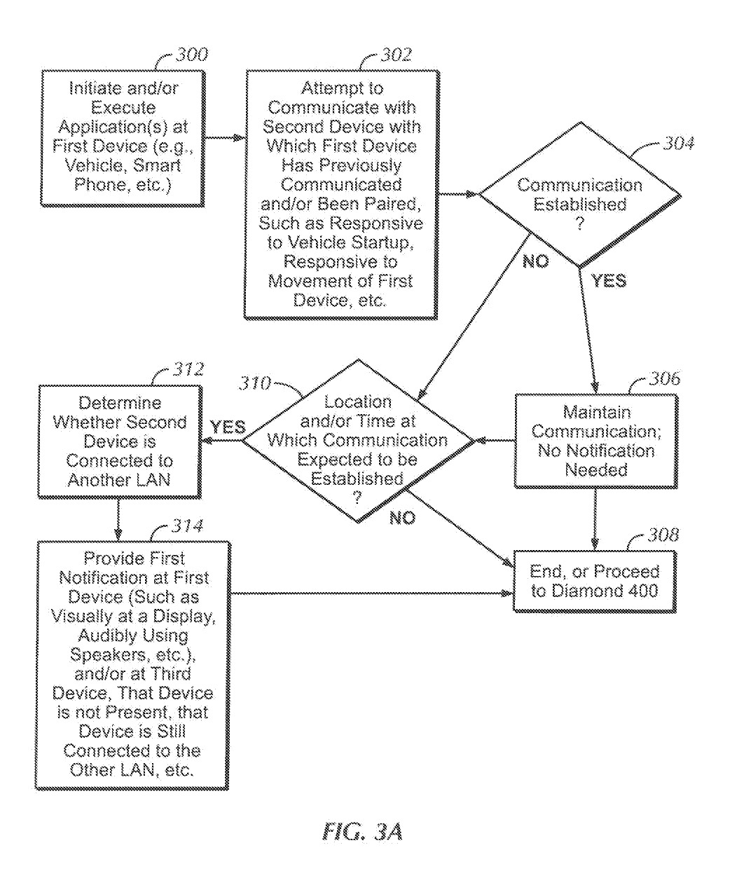

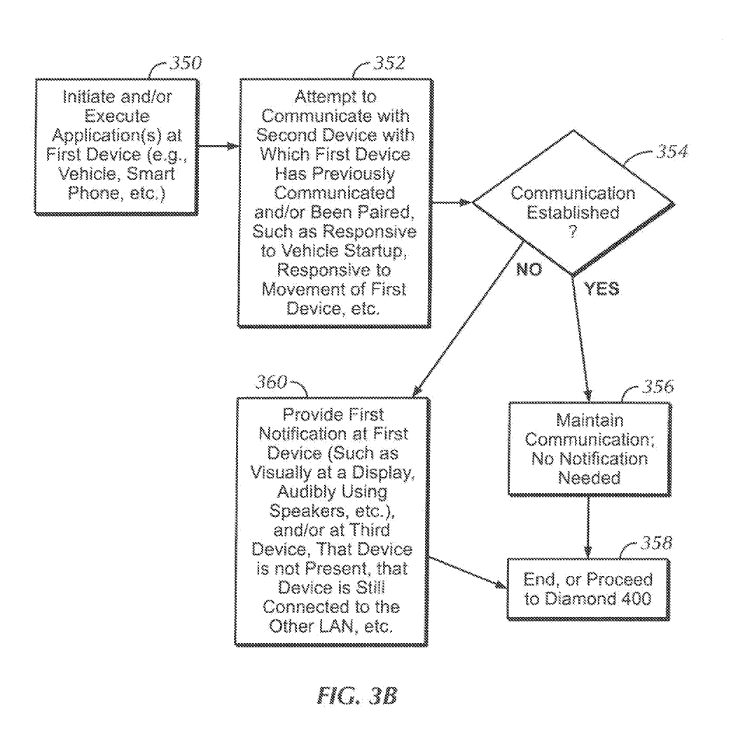

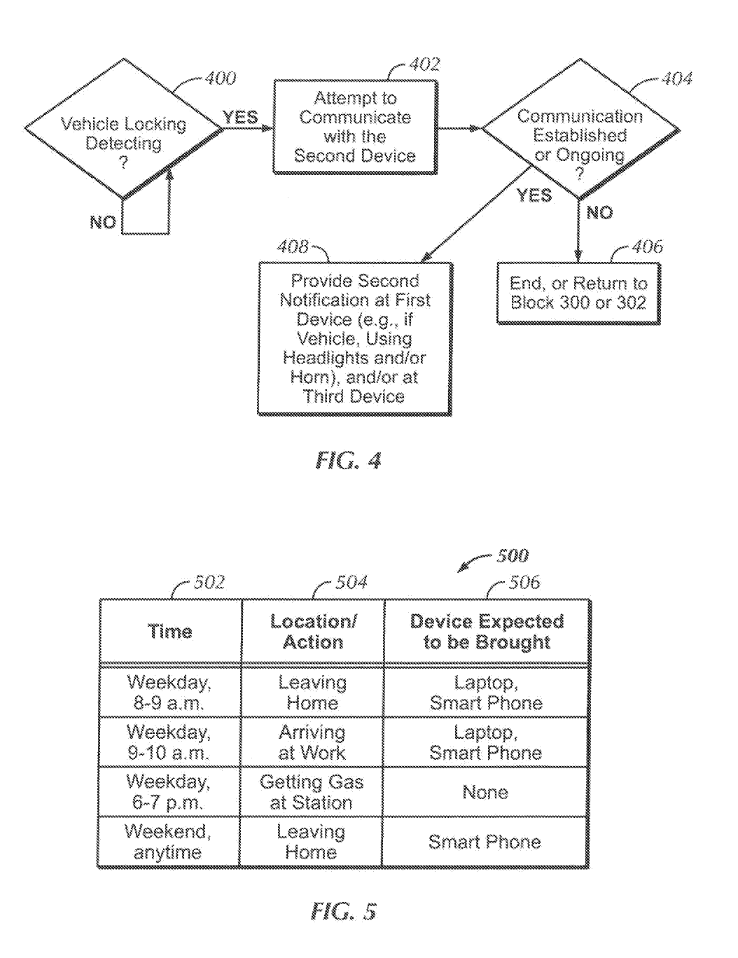

Now referring to FIG. 3A, it shows example logic that may be executed by a device such as the system 100 (referred to when describing FIGS. 3A, 3B, and 4 as the “first device”) for determining whether communication can be established between the first device and a second device and providing a notification if communication cannot be established in accordance with present principles, such as if a user forgot to bring the second device with him or her. Beginning at block 300, the first device may initiate and/or execute one or more applications for undertaking present principles, such as a phone-to-vehicle interface application, a Bluetooth, communication application, a device detection application, a vehicle control application, etc.

From block 300 the logic may move to block 302, at which the logic may attempt to communicate, using a communication interface such as a wireless communication interface (e.g., a Bluetooth transceiver or a near field communication (NFC) transceiver), with the second device with which the first device has previously communicated and/or previously been paired for communication. Thus, for instance, the attempt to communicate may be made using a protocol such as an NFC protocol or a Bluetooth communication protocol.

Furthermore, in some embodiments, the attempt to communicate at block 302 may be performed responsive to detection of movement of the first device. This may be detected based on signals indicating movement from, a GPS transceiver or accelerometer on the first device if the first device is separate from a vehicle but is determined to be disposed within the vehicle. Motion may also be determined based on detection of movement of the vehicle itself as indicated by, for example, signals from a GPS transceiver or accelerometer on the first device if the first device is disposed on or forms a part of the vehicle. Yet again, motion may be detected based on the first device communicating with the vehicle to receive a message from the vehicle that the vehicle is moving.

In addition to or in lieu of the foregoing, the attempt to communicate at block 302 may also be performed responsive to detection of startup of the vehicle, such as via detection of actuation of a vehicle ignition system. Also in addition to or in lieu of the foregoing, the attempt to communicate at block 302 may be performed responsive to detection of an unlocking of doors of the vehicle, such as based on detection of a vehicle unlock radio frequency (RF) signal from a key fob such as the key fob 218 described above, and/or receipt of a signal from the vehicle indicating it has been unlocked or has received a command to be unlocked if the first device is not part of the vehicle. Further, an attempt at communication may be executed upon the vehicle being put into gear, indicating that movement of the vehicle is imminent.

In any case, from block 302 the logic may next move to decision diamond 304, at which the logic may determine whether communication of the first device with the second device has been established, such as based on an exchange of presence signals between the first and second devices. This may also be based on other bilateral communication between the first and second devices using a Bluetooth or NFC protocol. In addition to or in lieu of the foregoing, the determination at decision diamond 304 may be based on commands being exchanged between the first and second devices, etc.

An affirmative determination at diamond 304 may cause the logic to move to block 306, where the logic maintains the communication that has been established and concludes that no notification of an inability of the first device to communicate with the second device is to be provided. From block 306 the logic may proceed to block 308, where it may end or proceed therefrom to decision diamond 400 of FIG. 4, which will be described below.

On the other hand, a negative determination at decision diamond 304 causes the logic to move to decision diamond 310, where the logic may determine whether a current location of the first device is a location at which communication of the first device with the second device is expected to be established. This determination may be made using coordinates from a GPS transceiver on the first device. Additionally or alternatively, it may be determined at decision diamond 304 whether the current time of day and/or current day is a time or day at which communication is expected to be established with the second device. To this end, the executing processor can access date and time information from an electronic clock.

In some embodiments, the determination at diamond 310 may be based on data in a history or database accessible to the first device regarding devices expected to communicate with the first device at the time and/or location, such as based on prior user patterns. For example, such history may be stored locally at the first device and/or at another location accessible to the first device, such as a cloud storage area. An example data table useable for such purposes will be described below in reference to FIG. 5.

Still in reference to decision diamond 310 of FIG. 3A, a negative determination causes the logic to proceed to block 308, where the logic may either conclude in some embodiments, or proceed to decision diamond 400 in other embodiments. In contrast, an affirmative determination at diamond 310 causes the logic to move to block 312. At block 312 the logic may determine whether the second, device is connected to another local area network other than one that would have been established by, e.g., paired NFC or Bluetooth communication between the first and second device, such as a user's home Wi-Fi network. The logic may do so at block 312 using an Internet connection (such as a cellular Internet connection) to thus communicate with the second device over the Internet connection and receive location information (e.g., GPS coordinates) from the second device and/or LAN connection information from the second device. The logic may also do so at block 312 using an Internet connection to communicate with a home automation system and/or Internet of things system associated with and communicating with the second device to determine whether the second device is still connected to the Internet of things network and/or Wi-Fi network associated therewith. In any case, from block 312 the logic may then proceed to block 314.

At block 314 the logic of FIG. 3A may provide a first notification to a user regarding the lack of communication with the second device. The first notification can indicate that the second device is not present at or proximate to the first device and/or user. Additionally or alternatively, the notice can indicate a location of the second device. Yet again, the notice can indicate that the second device is connected to the other LAN as identified at block 312. The first notification may be provided at the first device. The notice may also or alternatively be provided at a third device with which the first device communicates to provide the first notification, such as a smart watch identified as being currently worn by the user.

The first notification may be provided on a display of the first device and/or third device. As additional or alternative options, the notification may be provided audibly at the first device and/or third device. Non-limiting examples of an audible notification include a predetermined chime or tone, an automated voice indicating the content of the notification, and a predetermined horn honking length or pattern using a horn of a vehicle.

Visible notification on a device may not be confined to the display of the device. In some embodiments, notification of a lack of communication with the second device may be provided visually by illuminating a lamp, such as a light emitting diode (LED), on the first device. Similarly, visible notification may be provided using a predetermined headlight on and off actuation length or pattern using headlights of a vehicle.

In some embodiments, in addition to or in lieu of visible and audible modes of notification, the notification at block 314 may be provided haptically at the first device and/or third device. For example, a predetermined vibration length or pattern using a vibration element on the device may indicate a lack of communication with the second device. Regardless, note that once the first notification is provided at block 314, the logic may then proceed to block 308, where the logic may either conclude or proceed to diamond 400.

Also in some embodiments, the system may be configured to always provide a notification of the absence of communication of the first device with the second device, such as regardless of the time, date, and/or user patterns. Thus, an alternate embodiment to FIG. 3A is shown in FIG. 3B, where a first device may execute logic indicated at steps 350, 352, 354, 356, 358, and 360 respectively similar to logic indicated at steps 300, 302, 304, 306, 308, and 314, save for a negative determination at diamond 354 causing the logic to proceed directly to block 360.

Even further, it is to be understood that in still other embodiments, the determination at diamond 310 of FIG. 3A may be performed prior to an attempt to communicate at block 302, so that an affirmative determination that a current location/time is a location and/or time at which communication with the second device is expected to be established may cause the logic to take the actions described above in reference to block 302. Also in such an embodiment, a negative determination may cause the logic to end.

FIG. 4 shows example logic that may be executed independently of the example logic of FIGS. 3A and 3B, and/or in conjunction therewith. Beginning at decision diamond 400, the logic may determine whether a locking of a vehicle has been detected, such as a locking of doors of a vehicle based on a command from a key fob such as the key fob 218 described above. Thus, for instance, an affirmative determination at diamond 400 may be based on and made responsive to detection of a vehicle lock RF signal from the key fob. In addition or alternatively, an affirmative decision may be made responsive to receipt of a signal from the vehicle indicating it has been locked or has received a command to be locked.

An affirmative determination at diamond 400 causes the logic to move to block 402, which will be described shortly. A negative determination at diamond 400 may cause the logic to continue making the determination at diamond 400 until an affirmative one is made. Also note that the determination at diamond 400 may be made periodically at regular intervals or continually once the vehicle being in an unlocked state has been identified. In effect, state logic may be used, although for convenience of description the logic is illustrated in flow chart format.

At block 402 communication is attempted with a second device in accordance with present principles, such as in ways similar to those described above in reference to block 302. From block 402 the logic may next proceed to decision diamond 404. At diamond 404 the logic may determine whether communication with the second device has been established (such as in ways similar to those described above in reference to diamond 304) and/or whether already-established communication with the second device (such as may have been established during the execution of the logic of FIGS. 3A or 3B) is currently ongoing. A negative determination at diamond 404 may cause the logic to move to block 406, where the logic may end, or return to either of blocks 300 and 302 and proceed therefrom as described above.

However, note that an affirmative determination at diamond 404 may instead cause the logic to move to block 408, where the logic may provide a second notification regarding the fact that the second device is still communicating with the first device. This, may occur if the first device forms part of a vehicle that the user has locked and is walking away from. The second notification can indicate that the second device is still located within the vehicle. This notification may result from a comparison of GPS coordinates for the vehicle with GPS coordinates of the second device. In addition to or in lieu of the foregoing, it may result from determining that the second device remains in communication with the first device over a relatively short-range communication means such as Bluetooth communication, and/or that the second device is still proximate to the first device, etc.

The second notification may be provided at the first device (e.g.. a smart phone), and/or may be provided at a third device with which the first device communicates to provide the second notification, such as a smart watch identified as being currently worn by the user. The second notification may be provided on a display of the first device and/or third device. The second notification may be provided audibly at the first device and/or third device. Audible notifications may include but are not limited to a predetermined chime or tone, an automated, voice indicating the content, of the notification, and/or a predetermined horn honking length or pattern using a horn of a vehicle. Yet again, the second notification may be provided visually at the first and/or third device using something other than a display. As mentioned above, this can include illuminating an LED on the device, using a predetermined headlight on and off actuation length or pattern using headlights of a vehicle, etc.

As was the case with the first notification, the second notification may also or alternatively be presented using haptic feedback. For example, the second notification may be established by a predetermined vibration length or pattern using a vibration element on the device. After block 408 of FIG. 4, the logic may either end, or return to either of blocks 300 and 302 and proceed therefrom as described above.

Before moving on to the description of FIG. 5, note in reference to FIG. 4 that in addition to or in lieu of determining whether a locking of a vehicle has been detected at diamond 400, at diamond 400 the logic may determine whether the vehicle has been turned off or shot down. Responsive to an affirmative determination of such at diamond 400, the logic may proceed to block 402 as described above.

FIG. 5 shows an example data table 500 that may be used in accordance with present principles, such as at diamond 310 as described above. The data table 500 includes a first column 502 listing various times of day and/or days (days of the week, days of the month, days of the year, etc.) associated with various user patterns, a second column 504 listing various locations and/or actions associated with various user patterns, and a third column 506 listing various devices expected to be brought based on one or both of the data in columns 502 and 504.

Providing an example of how the table 500 may be used, a device undertaking present principles may identify a time of day and/or day of the week using an electronic clock. The device can then access the data table 500 and parse data in column 502 until an entry matching the actual time of day and day of the week is located in column 502. For embodiments which may use time ranges in the column 502 shown in FIG. 5, the matching time range is selected.

The logic then accesses the entry in column 506 corresponding to the matching entry in column 502 to identify one or more user-associated devices expected to be present or brought with the user based on the current actual time of day and/or day of the week. This information may then be used to make a determination such as the one described above in reference to diamond 310. For example, if an actual time of day is identified as falling within a time range listed in the second entry down in column 502 (falling within 9:00 to 10:00 a.m. during a weekday), the logic may proceed to the corresponding entry in column 506 to identity that a user is expected to bring his or her laptop and smart phone in this example.

As another example of how the table 500 may be used, a device undertaking present principles may identify a current location of a first device, access the data table 500, parse data in column 504 until a match is identified of the current actual location of the first device to a location listed in column 504, and then access a corresponding entry in column 506 to identify one or more user-associated devices expected to be present or brought with the user based on the current location, which may then be used to make a determination such as the one described above in reference to diamond 310. For example, if the current location of the first device is identified as being at or near a user's home (such as within a threshold distance thereof) and an action is identified as the user leaving his or her home, the logic may identify that this matches the data listed in the first entry down in column 504. The logic then accesses the corresponding entry in column 506 to identify that a user is expected to bring his or her laptop and smart phone in this example.

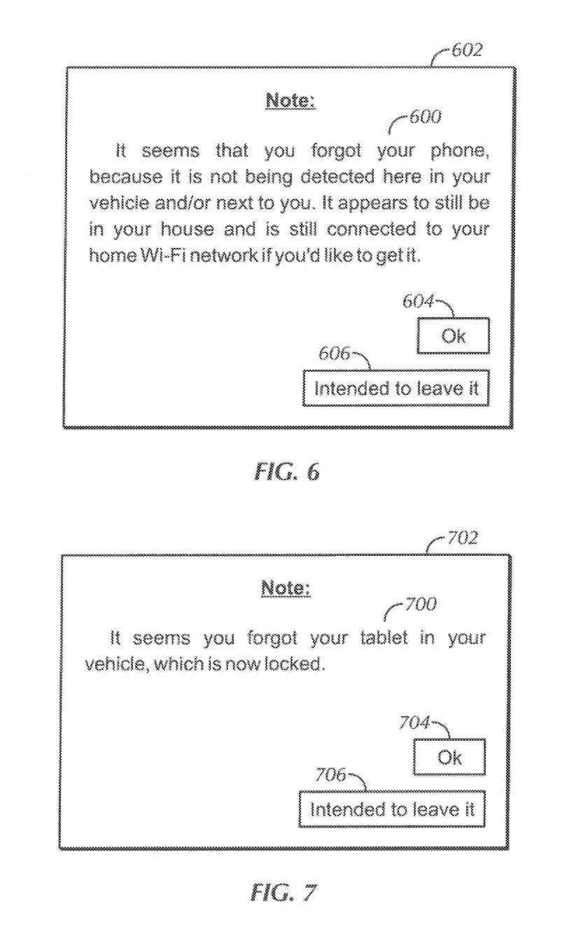

FIG. 6 shows an example of a notification 600 that can be presented as part of a user interface (UI) 602. The UI 602 may be presented on a display of a device in accordance with present principles. In some embodiments, the notification 600 may be an example of the first notification described above in reference to FIGS. 3A and 3B.

As may be appreciated from FIG. 6, the notification 600 may indicate one or more alpha-numeric messages. A message may be presented, as an example, that the user appears to have forgotten his or her phone. In this case, the phone would correspond to the second device described above in reference to FIGS. 3A, 3B, and 4. The message is presented because the phone has not been detected as present in the vehicle in which the user is assumed to be disposed in this example, and/or because the phone has not been detected as being proximate to the user and/or vehicle. In addition to or in lieu of the foregoing, the notification 600 may also indicate that the phone appears to still be in the user's house and/or is still connected to the user's home Wi-Fi network or Internet of things network.

Furthermore, in some embodiments, the UI 602 may include an “ok” selector 604 that is selectable to dismiss the notification 600. The UI 602 may be removed from display as a result.

The UI 602 may also include a selector 606 that is selectable to provide input to the device executing logic in accordance with present principles that the user intended to leave his or her phone at home. Thus, selection of selector 606 may be used by the device so that the device may dynamically learn a user's preferences for when the user typically desires to bring certain devices with him or her, and at what location this may occur. Thus, in some embodiments, data in a data table such as the table 500 described above may be created, modified, or updated by the device based on selection of the selector 606.

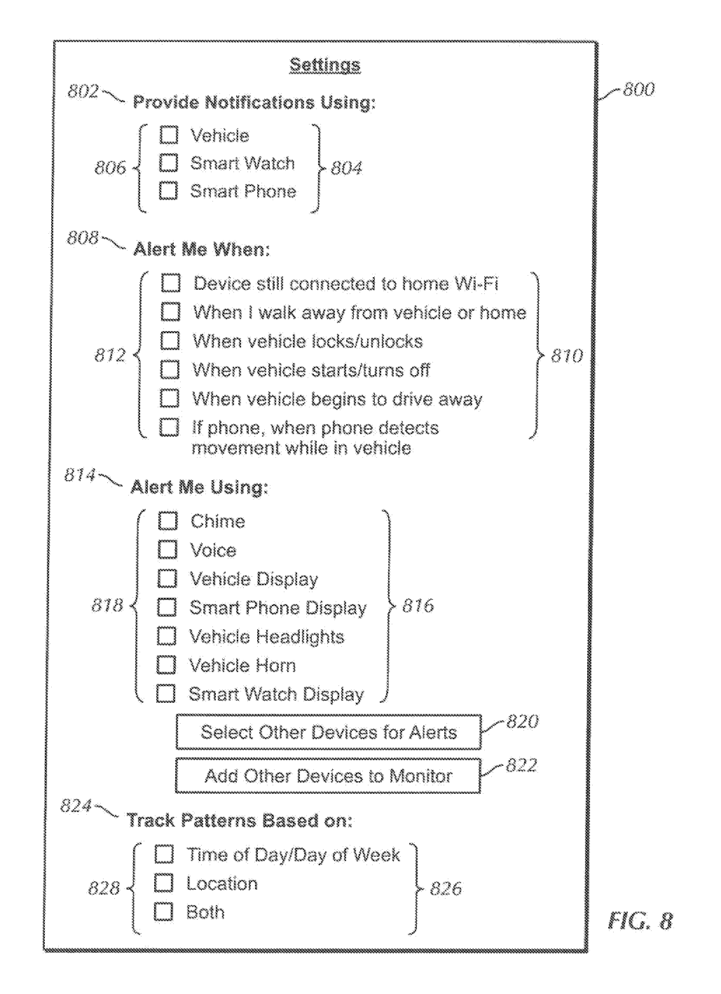

FIG. 7 shows another example notification 700 presented as part of a user interface (UI) 702 that itself may be presented on a display of a device (such as the first device described above in reference to FIGS. 3A, 3B, and 4) in accordance with present principles. In some embodiments, the notification 700 may be an example of the second notification described above in reference to FIG. 4.

As may be appreciated from FIG. 7, the notification 700 may indicate that the user seems to have forgotten/left his or her tablet computer in the user's vehicle, which the notification 700 indicates is now locked. Furthermore, in some embodiments, the UI 702 may include an “ok” selector 704 that is selectable to dismiss the notification 700 and/or UI 702 and hence provide a command for it to cease being presented on a display. The UI 702 may also include a selector 706 that is selectable to provide input to the device executing logic in accordance with present principles that the user intended to leave his or her tablet in the vehicle. Thus, like selection of selector 606, selection of selector 706 may also be used by the device so that the device may dynamically learn a user's preferences for when the user typically desires to bring certain devices with him or her, and at what location this may occur. In this case, location is associated with the vehicle itself rather than any specific geographical location at which the vehicle may be disposed as may be used in other embodiments.

Reference is now made to FIG. 8, which shows another example UI 800 presentable on a display controlled by a device such as the first device described above in reference to FIGS. 3A, 3B, and 4. The UI 800 may be operable by a user to configure settings of the device for undertaking present principles. Thus, the UI 800 may include a first setting 802 for a user to select one or more devices 804 on which to present, notifications in accordance with present principles by selecting one or more of check boxes 806 respectively associated with each of the devices 804.

The UI 800 may also include a second setting 808 for a user to select one or more circumstances and/or conditions 810 under which the user desires to be provided with a notification in accordance with present principles by selecting one or more one or more of cheek boxes 812 respectively associated with each of the circumstances and/or conditions 810. As may be appreciated from FIG. 8, examples of such circumstances and/or conditions may include that the device is still connected to a LAN such as a home Wi-Fi network or Internet of things network, when the user walks away from, his or her vehicle or home, when the user's vehicle locks or unlocks, when the user's vehicle begins to drive and/or move (e.g., subsequent to vehicle startup), and when the user's personal device detects movement of it while disposed within a vehicle (such as in embodiments where the personal device, rather than a vehicle, is the “first device” described above in reference to FIGS. 3A, 3B, and 4).

Still in reference to FIG. 8, the UI 800 may also include a third setting 814 for a user to select one or more types of notifications to be provided in accordance with present principles by selecting one or more of check boxes 818 respectively associated with each of the notification types. Examples notification types include a chime or tone notification, an automated voice notification, a notification on a vehicle display, a notification on a personal device display, a haptic notification, a notification via vehicle headlights, and a notification via vehicle's horn.

In some embodiments, the UI 800 may also include a selector 820 that is selectable to command the device presenting the UI 800 to present another UI at which other devices may be input and/or selected for display of notifications and/or alerts in accordance with present principles. Still further, the UI 800 may include another selector 822, this one being selectable to command the device to present a UI at which other devices may be input and/or selected for which the device is to attempt to communicate and provide notifications and/or alerts if not present (or if still present in a vehicle such as after locking) in accordance with present principles.

Last, the example UI 800 of FIG. 8 may also include a fourth setting 824 for a user to select one or more options 826 respectively for using time of day and/or day of the week for determining whether to attempt to communicate with another device and provide notifications based thereon in accordance with present principles, for using location for determining whether to attempt to communicate with another device and provide notifications based thereon in accordance with present principles, and for using both time of day/day of week and location for determining whether to attempt to communicate with another device and provide notifications based thereon in accordance with present principles. Each of the options 826 may be selected using a respective check box 828 associated therewith.

Although only certain types of settings and selectors have been described above in reference to FIG. 8, other settings and selectors useful for undertaking present principles may also be presented. For instance, a setting or selector for configuring a vehicle to communicate over the Internet or with a user's Internet of things network to identify the location of a second device in accordance with present principles may also be presented on the UI 800.

It is to be understood that in addition to wireless communication interfaces being used in accordance with present principles, wired communication interfaces may also be used. For instance, the decision made at diamond 304 above may be based on whether wired communication has been established between, a first and second device, such as may be the case where a second device such as a smart phone is configured to communicate with a first device (in this case, a vehicle) via a wired connection and/or docking station in the vehicle.

Before concluding, it is to be understood that although a software application for undertaking present principles may be vended with a device such as the system 100, present principles apply in instances where such an application is downloaded from a server to a device over a network such, as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein.

What is claimed is:

1. A first device, comprising:
a processor;
a communication interface accessible to the processor; and
storage accessible to the processor and bearing instructions executable by the processor to:
attempt to communicate, using the communication interface, with a second device with which the first device has previously communicated; and
responsive to a determination that communication cannot be established with the second device, provide a notification indicating that the second device is not present.

2. The first device of claim 1, wherein the communication interface is selected from the group consisting of: a Bluetooth transceiver, a near field communication (NFC) transceiver.

3. The first device of claim 1, wherein the notification is provided at the first device.

4. The first device of claim 1, wherein the notification is provided at a third device different from the first device and the second device.

5. The first device of claim 4, wherein the first device is a vehicle, and wherein the vehicle communicates with the third device to provide the notification.

6. The first device of claim 1, wherein the notification indicates that the second device is at a first location different from a second location of the first device.

7. The first device of claim 1, wherein the notification is provided on a display.

8. The first device of claim 1, wherein the notification is provided one or more of audibly and visually.

9. The first device of claim 1, wherein the first device is a vehicle, wherein the notification is a first notification, and wherein the instructions are executable by the processor to:
attempt to communicate, using the communication interface, with the second device responsive to a locking of the vehicle; and
responsive to communication with the second device subsequent to the locking of the vehicle, provide a second notification.

10. The first device of claim 1, wherein the instructions are executable by the processor to:
attempt to communicate, using the communication interface, with the second device responsive to detection of startup of a vehicle.

11. The first device of claim 1, wherein the instructions are executable by the processor to:
attempt to communicate, using the communication interface, with the second device responsive to detection of movement of a vehicle.

12. The first device of claim 1, wherein the instructions are executable by the processor to:
attempt to communicate, using the communication interface, with the second device responsive to detection of movement the first device while in communication with a vehicle.

13. A method, comprising:
at a first device, attempting to communicate with a second device with which the first device has previously been paired for communication; and
responsive to a failure to communicate with the second device based on the attempting, providing a notification.

14. The method of claim 13, wherein the notification is a first notification, and wherein the method comprises:
attempting to communicate with the second device responsive to identifying a locking of a vehicle; and
responsive to identifying that the first device is communicating with the second device subsequent to the locking of the vehicle, providing a second notification.

15. The method of claim 14, wherein the second notification is provided using one or more of headlights of the vehicle and a horn of the vehicle.

16. The method of claim 13, comprising:
responsive to a failure to communicate with the second device based on the attempting, determining whether the second device is connected to a first local area network (LAN) different from, a second LAN established by paired communication of the first device with the second device; and
providing the notification responsive to determining that the second device is connected to the first LAN.

17. The method of claim 13, comprising:
responsive to a failure to communicate with the second device based on the attempting, determining whether the second device is connected to a first local area network (LAN) different from a second LAN established by paired communication of the first device with the second device; and
providing the notification, the notification indicating one or more of: a location of the second device, that the second device is not present, that the second device is not proximate to the first device, and that the second device is connected to the first LAN.

18. A first device, comprising:
a processor;
a communication interface accessible to the processor; and
storage accessible to the processor and bearing instructions executable by the processor to:
based on one or more identified user patterns, attempt to communicate, using the communication interface, with a second device with which the first device has previously communicated; and
responsive to an inability to communicate with the second device, take a first action.

19. The first device of claim 18, wherein the instructions are executable by the processor to:
responsive to an inability to communicate with the second device, determine that the second device has been unintentionally left at a first location different from a second location at which the first device is currently located; and
responsive to the determination that the second device has been unintentionally left at the first location, take the first action, the first action comprising notifying a user.

20. The first device of claim 18, wherein the attempt to communicate is performed in a first instance, and wherein the instructions are executable by the processor to:
in a second instance and based on one or more identified user patterns, determine that communication with the second device is not expected to be established; and
based on the determination that communication with the second device is not expected to be established, decline to take a second action.
